(19) United States
(12) Patent Application Publication
(10) Pub. No.: US 2024/0187500 A1
(43) Pub. Date: Jun. 6, 2024

(54) INTELLIGENT CONTENT DELIVERY FACILITATION WITH EDGE COMPUTING

(71) Applicant: International Business Machines Corporation, Armonk, NY (US)

(72) Inventors: Suman Patra, Kolkata (IN); NEIL DELIMA, Scarborough (CA); Hunter Medney, Durham, NC (US)

(21) Appl. No.: 18/062,183

(22) Filed: Dec. 6, 2022

(51) Int. Cl. H04L 67/62; H04L 67/50

(52) U.S. Cl. CPC H04L 67/62; H04L 67/535

(57) ABSTRACT

Intelligently facilitating content data for a user to consume by utilizing edge computing. In some instances, an intelligent virtual agent is used to collect user data (including scheduling data, historical data, location data, type of content that the user consumes, and the like). This collected user data is used to predict, in part, the time and location where the user is likely to consume this content. Based on this predicted time and location, the content that the user is likely to consume is forwarded to an edge gateway so that this content is readily available to the user.

### BACKGROUND

The present invention relates generally to the field of edge computing, and more specifically to efficiently delivering content to users through the use of edge computing.

The Wikipedia Entry for “Edge computing” (as of Nov. 21, 2022) states as follows: “Edge computing is a distributed computing paradigm that brings computation and data storage closer to the sources of data. This is expected to improve response times and save bandwidth. It is an architecture rather than a specific technology. It is a topology- and location-sensitive form of distributed computing . . . In the early 2000s, these networks evolved to host applications and application components at the edge servers, resulting in the first commercial edge computing services that hosted [a variety of] applications . . . Internet of things (IOT) is an example of edge computing. A common misconception is that edge and IoT are synonymous.”

The Wikipedia Entry for “Multi-access edge computing” or “MEC” (as of Nov. 21, 2022) states as follows: “Multi-access edge computing (MEC), formerly mobile edge computing, is an ETSI-defined network architecture concept that enables cloud computing capabilities and an IT service environment at the edge of the cellular network and, more in general at the edge of any network. The basic idea behind MEC is that by running applications and performing related processing tasks closer to the cellular customer, network congestion is reduced and applications perform better. MEC technology is designed to be implemented at the cellular base stations or other edge nodes, and enables flexible and rapid deployment of new applications and services for customers. Combining elements of information technology and telecommunications networking, MEC also allows cellular operators to open their radio access network (RAN) to authorized third parties, such as application developers and content providers.”

### SUMMARY

According to an aspect of the present invention, there is a method, computer program product and/or system that performs the following operations (not necessarily in the following order): (i) collecting, by an intelligent agent, a user activity data set, with the user activity data set including information indicative of current and historical scheduled activities for a first set of user(s); (ii) determining, by a machine learning module, a content consumption schedule for the first set of user(s); (iii) responsive to the determination of the content consumption schedule, receiving, by the intelligent agent, a set of content data, with the set of content data including information indicative of relevant information that will be utilized by the first set of user(s); (iv) determining, by the intelligent agent, that a first user will perform a first action at a first point in time; and (v) sending, by the intelligent agent, the first set of content data to a first edge gateway at the first point in time.

According to an aspect of the present invention, there is a method, computer program product and/or system that performs the following operations (not necessarily in the following order): (i) collecting, by an intelligent agent, schedule data and historical, with the schedule data including planned activities, and with the historical data including location, time, activity and category of consumed content for one or more users; (ii) predicting, by a content prediction module, location, time and content consumption for the one or more users using the schedule data and the historical data collected by the intelligent agent to obtain a set of user prediction data; (iii) responsive to obtaining the set of user prediction data, receiving, from a content source, the content data for the one or more users; and (iv) forwarding the received content data to a forwarding location including Edge Gateway or MEC location, with the forwarding location being determined based on the set of user prediction data.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system; and

FIG. 4 is a system diagram showing information that is helpful in understanding embodiments of the present invention.

### DETAILED DESCRIPTION

Some embodiments of the present invention are directed towards intelligently facilitating content data for a user to consume by utilizing edge computing. In some instances, an intelligent virtual agent is used to collect user data (including scheduling data, historical data, location data, type of content that the user consumes, and the like). This collected user data is used to predict, in part, the time and location where the user is likely to consume this content. Based on this predicted time and location, the content that the user is likely to consume is forwarded to an edge gateway so that this content is readily available to the user.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

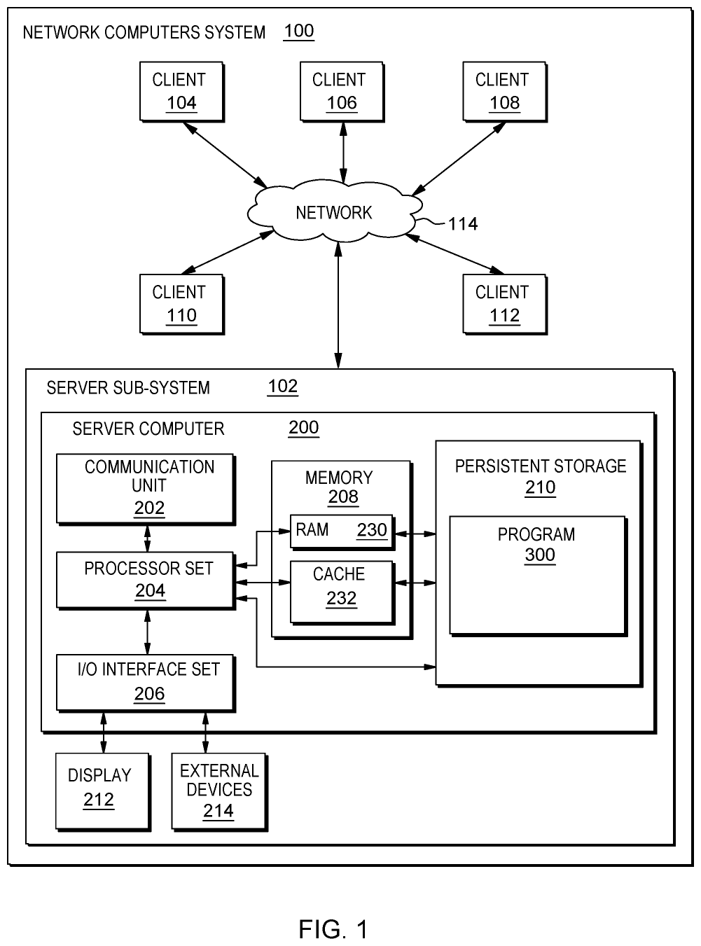

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

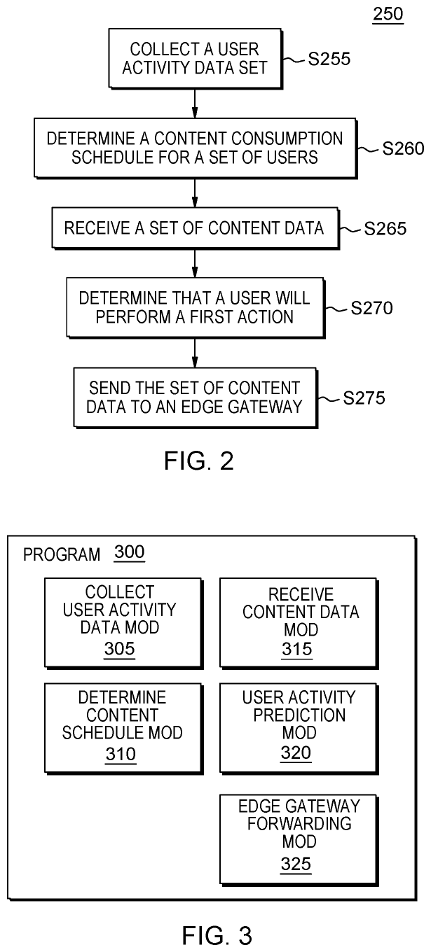

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where collect user activity data module (“mod”) 305 collects a set of user activity data. In some embodiments of the present invention, collect user activity data mod 305 collects data relating to a user's current and historical activities with respect to any given activity where data can reasonably be collected. For example, in some embodiments, mod 305 collects activity related data from a user's personal calendar on his or her mobile phone and/or personal computer.

In some embodiments of the present invention, collect user activity data mod 305 collects a user's (or set of users') historical activity data. This historical activity data includes: (i) information relating to a location in which the user consumed certain content; (ii) a time (or set of times) in which the user consumed certain content; (iii) the activity that the user was performing while consuming the content; and/or (iv) a general category of the content that was consumed by the user.

Processing proceeds to operation S260, where determine content schedule mod 310 determines a content consumption schedule for a specific user or for a set of users. In some embodiments of the present invention, determine content schedule mod 310 uses machine learning methods to reliably determine which content the user consumes at any given point in time. Sometimes, this determination is based on schedule information that is stored on the user's mobile device or personal computer. In other instances, this determination is based on a pattern that is discerned from the user's location information and habits. For example, using machine learning methods, determine content schedule mod 310 can learn that when a user regularly visits a first location (such as a stadium), the user tends to access information relating to a set of sports websites, and more specifically, to a single team. Additionally, in this same example, determine content schedule mod 310 can learn, through machine learning methods, that three (3) to four (4) hours after arriving at the stadium, the user does not have any events scheduled on his or her personal calendar, but tends to visit a cluster of restaurants that are located a few miles away from the stadium.

In some embodiments, determine content schedule mod 310 utilizes machine learning techniques that are understood by persons having ordinary skill in the art including, but not necessarily limited to, the following: supervised learning, unsupervised learning, reinforcement learning, semi-supervised learning, self-supervised learning, multi-instance learning, inductive learning, deductive inference, transductive learning, multi-task learning, active learning, online learning, transfer learning and/or ensemble learning.

Processing proceeds to operation S265, where receive content data mod 315 receives a set of content data. Continuing from the example provided above in connection with operation S260, receive content data mod 315 initially receives multimedia content relating to the sports team that is playing at the stadium. In some embodiments, this multimedia content can be received and stored on an origin server (that is, a central server in which all content that is accessed by a user is stored prior to that same content being distributed to a single edge gateway or a plurality of edge gateways). Additionally, three (3) to four (4) hours after arriving at the stadium, receive content data mod 315 receives multimedia information relating to the various restaurants that the user typically visits (such as menu information, restaurant rating, restaurant reviews, and the like) and stores this information on the origin server.

Processing proceeds to operation S270, where user activity prediction mod 320 determines and/or otherwise predicts that a user will perform a certain action. Continuing from the example provided in connection with operations S260 and S265, user activity prediction mod 320 uses machine learning methods (discussed in connection with operation S260, above) to determine that a user will perform a certain action (such as going to a sports event at a specified location) based on information that is recorded in the user's personal calendar (that is stored on the user's mobile phone and/or personal computer). Additionally or alternatively, user activity prediction mod 320 uses machine learning methods to predict whether a user will perform a particular action that the user has performed in the past (in this example, visiting a cluster of restaurants at a regular period after the start of the sporting event).

Processing finally proceeds to operation S275, where edge gateway forwarding mod 325 sends the set of content data (discussion in connection with operation S265, above) to an edge gateway. Continuing from the example provided in connection with operations S260, S265 and S270, edge gateway forwarding mod 325 sends the multimedia content relating to the sports team from the origin server to an edge gateway that is physically closest to the stadium before the start of the sporting event. In some embodiments, this multimedia content can be forwarded from the origin server to the edge gateway closest to the stadium as soon as the user enters information specifying that the user will attend the sporting event in his or her personal calendar, which is, in some instances, immediately collected by collect user activity data mod 305 (discussed in connection with operation S255, above). Additionally, in some embodiments, edge gateway forwarding mod 325 uses the predicted user activity data (received from user activity prediction mod 320) to pre-emptively send multimedia content relating to the cluster of restaurants to the edge gateway that is physically closest to that same cluster at the start of the sporting event. Additionally or alternatively, in the event that edge gateway forwarding mod 325 cannot send the consumable user content to a server that is physically closest to a user activity location, then mod 325 can route the consumable content to an alternative edge gateway that is: (i) still relatively close to the intended edge gateway, and (ii) has the adequate bandwidth to route and store the consumable content for the duration in which the user will need that same content.

### III. Further Comments and/or Embodiments

Companies big and small are modernizing their applications and migrating them to the cloud. In some instances, more than twenty-eight percent (28%) of an organization's total Information Technology (IT) budget is now kept aside for cloud computing. Today, 70 percent of organizations have at least one application in the cloud, indicating that enterprises are realizing the benefits of cloud computing and are slowly adapting. Even as companies and industry experts predict the future growth of cloud computing, experts believe that the cloud has reached the end of its run at the top and are betting on the growing popularity and benefits of edge computing.

Edge computing is typically used to process time-sensitive data, while cloud computing is used to process data that is not time-driven. Despite having latency-related concerns, edge computing is preferred over cloud computing in remote locations, where there either is limited or no connectivity to a centralized location.

In this polyglot persistence model associated with edge computing, the data associated with the service needs to be constantly replicated across the Edge. But in cases, where entities in the edge computing devices constantly change location (such as a vehicle), latency starts to become an issue particularly when data is not available at the Edge for computing when needed. An example of this is an Internet of Things (IOT) sensor feed that is received from vehicles that need to be analyzed and used for real time decision making. Part of the data needed might reside in a remote cloud server location which can result in processing latency, which is an issue in such scenarios.

Embodiments of the present invention are centered around discovering and predicting mobility and content consumption for individuals or small groups, and then proactively requesting the delivery of such content for these individuals or small groups.

Some embodiments of the present invention include the following features, characteristics and/or advantages: (i) an intelligent virtual agent (or virtual personal assistant) that discovers planned activities by examining calendar schedules, GPS routes, to do lists, etc., as well as historic data consumption at different locations and in different situations for an individual user or a small group of users; (ii) a location and content consumption prediction engine that accepts inputs from the agent and predicts content consumption; (iii) an Origin Server Content Request Handler that can receive content requests from the intelligent virtual agent/virtual personal assistant and push this same content to Edge Gateways and Satellite or multi-access edge computing (MEC) locations; and (iv) a local mobile edge gateway that receives and stores content for future consumption.

Embodiments of the present invention include a method for intelligently facilitating the delivery of user content through edge computing. Aspects of this method include at least the following:

(1) The system consists of a virtual assistant (sometimes herein referred to as an “agent,” “intelligent agent,” and/or “intelligent virtual agent”) which is a key component of the Intelligent Content Delivery Facilitation invention system. The agent is configured to examine common scheduling and activity sources of data such as calendars, GPS applications, mail, messaging, etc. The virtual assistant can leverage existing virtual assistant technology to capture such location and activity related data about the end user or a group of users.

(2) The agent captures and logs monitoring data that includes the location, times, type of activity (inferred), content consumed at that time and the class or category of content consumed. When the category is not readily known, embodiments of the present invention can leverage techniques such as sampling a portion of content, converting it to natural language (NL) and performing NL classification to classify the type of content using an existing pretrained content classification model.

(3) The virtual assistant then feeds this data to a system data warehouse for further analysis and prediction.

(4) The Intelligent Content Delivery Facilitation system consists of a Content and Location Analysis component and a Prediction component. The predictive modelling engine can leverage an existing predictive modelling methods such as Gradient Boost classification or K-Means clustering.

(5) The inputs to this component's prediction model includes the current schedule data delivered to the data warehouse from the virtual assistant as well as historic location and content consumption data. The outputs are a series of predictions that include content consumption at different locations aligned with the user's schedule.

(6) The virtual agent receives these recommendations for content consumption at different locations and times and forwards these requests to the Origin Server Content Request Handler.

(7) The Origin Server Content Request Handler can be implemented as a REST service that proxies a content origin server to fetch content and deliver it to the Edge location it is configured to communicate with. The location of the Edge will be determined by the location of the predicted content consumption request.

(8) Embodiments of the present invention can optionally include an IoT Edge Gateway that resides in the proximity of the consuming devices. In some embodiments, the IoT Edge Gateway contains flash storage to cache content pushed form the Origin Server Content Request Handler. The IoT Edge Gateway will need to establish secure connectivity to the Origin Server Content Request to permit it to accept content delivered to it. Additionally, embodiments of the present invention secure connectivity and access control can be established using protocols like HTTPS and secure URLs or API tokens.

Consider the following example:

BCD Climate Services performs HVAC maintenance for commercial buildings. These are complex systems with a wide variety of system manufacturers and configurations. BCD's service technicians visit multiple buildings each day and require extensive data on each system, its maintenance history, and government filings. Technicians access all this data from a mobile application developed by BCD.

In order to ensure that technicians can access data on-site in the BCD app in a timely manner, relevant content for that day's work is intelligently delivered to edge network access points close to each job site. The agent (such as a proxy) has access to each technician's customer schedule from BCD's corporate calendar and anticipates which data will be most relevant for the technician based on client and technician access patterns. Examples includes blueprints, knowledge resources, maintenance history, etc.

Another example to demonstrate embodiments of the present invention is given below:

ABC Tours operates a tour bus business offering tourists several multi-day bus trips across different destinations. ABC Tours provides Wi-Fi and various entertainment options such as virtual and augmented reality views of tourist destinations, movies, games and audio books to keep its customers entertained during long trips. By utilizing embodiments of the present invention, the Intelligent Agent would first capture information about the tourist route and determine data and content that applies and is related to the route such as maps, local entertainment, virtual reality (VR)/augmented reality (AR) views of tour destination and sightseeing points of interest.

From the passenger itinerary and personal preferences, fetched by the intelligent agent, a content prediction engine would predict additional content that might be of interest based on passenger profiles and generate a list of potential entertainment content such as movies that might be of interest and audio books. The agent would the send a content request to a content request handler (or handlers). In some embodiments, the agent would also provide details about the destination for content delivery which in this case would be an Edge Gateway residing in the tour bus with sufficient storage to cache content of potential interest. The content request handler would service this request and deliver content to the Edge Gateway destination. Content requests by passengers during the journey such as a virtual tour of a site can now be served from the cached content at the Gateway instead of having to be fetched from an origin server.

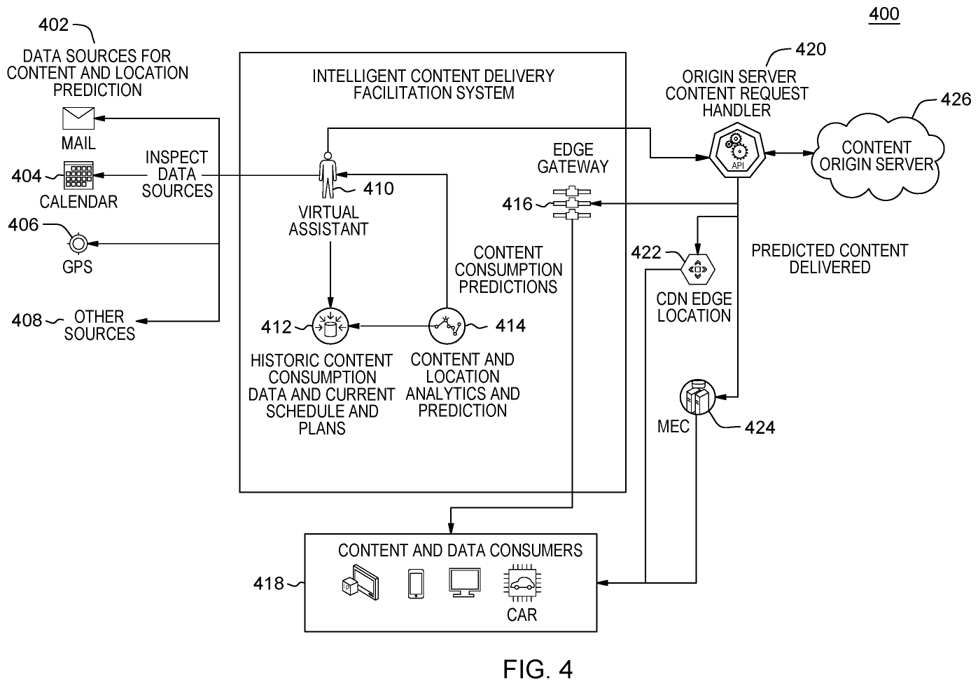

System diagram 400 of FIG. 4 shows the various components needed to implement certain embodiments of the present invention. System diagram 400 includes: data sources 402, calendar data 404, GPS data 406, additional data sources 408, virtual assistant 410, historic content 412, content and location analytics and prediction module 414, edge gateway 416, content and data consumers 418, origin server content request handler 420, CDN edge location 422, MEC 424, and content origin server 426.

Some embodiments of the present invention include a method for intelligently facilitating the delivery of content to a user (or sub-set of users of a group) through an edge gateway system. Operations for this method include the following (not necessarily in the following order): (i) collecting, by an intelligent agent (virtual assistant), schedule data including planned activities, and historical data including location, time, activity and category (class, type) of consumed content for one or more users; (ii) predicting location, time and content consumption for the one or more users using the schedule data and historical data collected by the intelligent agent; (iii) based on the predicted location, time, and content consumption, requesting to and receiving from a content source the content data; and (iv) forwarding the received content data to an Edge Gateway, Satellite or MEC location, selected based on the predicted location of content consumption. Additionally, in some embodiments, this method provides for caching the content data received from the content source to IoT Edge Gateway that resides in the proximity of the one or more users' devices for the predicted future consumption by the one or more users.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
collecting, by an intelligent agent, a user activity data set, with the user activity data set including information indicative of current and historical scheduled activities for a first set of users;
determining, by a machine learning module, a content consumption schedule for the first set of users;
responsive to the determination of the content consumption schedule, receiving, by the intelligent agent, a set of content data, with the set of content data including information indicative of relevant information that will be utilized by the first set of users;
determining, by the intelligent agent, that a first user will perform a first action at a first point in time; and
sending, by the intelligent agent, the first set of content data to a first edge gateway at the first point in time.

2. The CIM of claim 1 wherein the content consumption schedule for the first set of users includes information indicative of a plurality of time periods where at least one user of the first set of users accessed content during a scheduled activity.

3. The CIM of claim 1 wherein the intelligent agent sends the first set of content data to an edge gateway that is physically close to a location in which the first set of users will perform the first action.

4. The CIM of claim 1 wherein the intelligent agent sends the first set of content data to an edge gateway that is regularly accessed by the first set of users.

5. The CIM of claim 1 wherein the intelligent agent receives a set of recommended content for consumption by the first set of users from an origin content request server based, at least in part, upon a current location of the first set of users.

6. The CIM of claim 5 wherein the origin content request server acts as a proxy to receive the first set of content data and send it to a network of edge gateways.

7. A computer program product (CPP) comprising:
a machine readable storage device; and
computer code stored on the machine readable storage device, with the computer code including instructions and data for causing a processor(s) set to perform operations including the following:
collecting, by an intelligent agent, a user activity data set, with the user activity data set including information indicative of current and historical scheduled activities for a first set of users,
determining, by a machine learning module, a content consumption schedule for the first set of users,
responsive to the determination of the content consumption schedule, receiving, by the intelligent agent, a set of content data, with the set of content data including information indicative of relevant information that will be utilized by the first set of users,
determining, by the intelligent agent, that a first user will perform a first action at a first point in time, and
sending, by the intelligent agent, the first set of content data to a first edge gateway at the first point in time.

8. The CPP of claim 7 wherein the content consumption schedule for the first set of users includes information indicative of a plurality of time periods where at least one user of the first set of users accessed content during a scheduled activity.

9. The CPP of claim 7 wherein the intelligent agent sends the first set of content data to an edge gateway that is physically close to a location in which the first set of users will perform the first action.

10. The CPP of claim 7 wherein the intelligent agent sends the first set of content data to an edge gateway that is regularly accessed by the first set of users.

11. The CPP of claim 7 wherein the intelligent agent receives a set of recommended content for consumption by the first set of user(s) from an origin content request server based, at least in part, upon a current location of the first set of users.

12. The CPP of claim 11 wherein the origin content request server acts as a proxy to receive the first set of content data and send it to a network of edge gateways.

13. A computer system (CS) comprising:
a processor(s) set;
a machine readable storage device; and
computer code stored on the machine readable storage device, with the computer code including instructions and data for causing a processor(s) set to perform operations including the following:
collecting, by an intelligent agent, a user activity data set, with the user activity data set including information indicative of current and historical scheduled activities for a first set of users,
determining, by a machine learning module, a content consumption schedule for the first set of users,
responsive to the determination of the content consumption schedule, receiving, by the intelligent agent, a set of content data, with the set of content data including information indicative of relevant information that will be utilized by the first set of users,
determining, by the intelligent agent, that a first user will perform a first action at a first point in time, and
sending, by the intelligent agent, the first set of content data to a first edge gateway at the first point in time.

14. The CS of claim 13 wherein the content consumption schedule for the first set of users includes information indicative of a plurality of time periods where at least one user of the first set of users accessed content during a scheduled activity.

15. The CS of claim 13 wherein the intelligent agent sends the first set of content data to an edge gateway that is physically close to a location in which the first set of users will perform the first action.

16. The CS of claim 13 wherein the intelligent agent sends the first set of content data to an edge gateway that is regularly accessed by the first set of users.

17. The CS of claim 13 wherein the intelligent agent receives a set of recommended content for consumption by the first set of user(s) from an origin content request server based, at least in part, upon a current location of the first set of users.

18. The CS of claim 17 wherein the origin content request server acts as a proxy to receive the first set of content data and send it to a network of edge gateways.
